(19) United States
(12) Patent Application Publication
(10) Pub. No.: US 2008/0064810 A1
(43) Pub. Date: Mar. 13, 2008

(54) Imprinting Using Dendrimers as Templates

(76) Inventors: Borje Sellergren, Dortmund (DE); Andrew J. Hall, Dortmund (DE)

Correspondence Address: SCHWEGMAN, LUNDBERG & WOESSNER, P.A., P.O. BOX 2938, MINNEAPOLIS, MN, 55402, US

(21) Appl. No.: 11/662,463

(22) PCT Filed: Sep. 12, 2005
(86) PCT No.: PCT/SE05/01330

§ 371 Date: Aug. 23, 2007

(30) Foreign Application Priority Data
Sep. 10, 2004 (SE) 0402187-9

(51) Int. Cl. C08F 12/08; C08F 120/06; C08F 120/56; C08K 3/36

(52) U.S. Cl. 524/555; 524/556; 524/577; 526/303.1; 526/317.1; 526/346; 526/347.1

(57) ABSTRACT

Molecularly imprinted polymers created with dendrimers or other hyper branched polymer templates provide superior configuration options for the recognition of macromolecules.

### FIELD OF THE INVENTION

The present invention relates to the use of dendrimers or hyperbranched polymers as templates in molecular imprinting and to the use of the resultant molecularly imprinted polymers in the recognition of macromolecules.

### BACKGROUND OF THE INVENTION

Molecular imprinting is a key technology in analytical and separation sciences. The term refers to the synthesis of cross-linked polymers in the presence of templates, which may be small molecules, biological macromolecules, micro-organisms or crystals (B. Sellergren, Angew. Chem. Int. Ed. Engl. 39 (2000) 1031-1037).

The beauty of the molecular imprinting concept lies in its inherent simplicity. Functional monomers and the template to be imprinted form solution complexes which are subsequently incorporated into a cross-linked matrix upon polymerization. Removal of the template leaves behind sites with a precise geometry and orientation of functional groups, allowing subsequent recognition of the template or a structurally-related compound. The molecularly imprinted polymer (MIP) thus created contains nanometer-sized binding sites in addition to larger sized pores. For guest molecules to access the host binding site they must penetrate pores, the size of which are difficult to control independently from the generation of the imprinted site. One way to decouple these processes is to immobilize the template on the surface of porous, disposable solids that act as molds to create a desired porosity.

In this way, the pore system is determined by the solid mold regardless of the conditions used to generate the imprinted sites. In addition, all imprinted sites are confined to the porous wall surface of the resulting material. Thus, access to these sites can be controlled by the porosity of the solid mold which may, in turn, allow substructures of larger target molecules to be recognized by the surface-exposed sites. The feasibility of this approach has been demonstrated in the imprinting of small molecules, i.e. nucleotide bases (Titirici et al., Chem. Mater. 14 (2002) 21-23) and small drugs (Yilmaz et al., Angew. Chem., Int. Ed. Engl. 39 (2000) 2115-2118).

Despite advances in molecular imprinting, the recognition of larger proteins has proven difficult. Particularly lacking in the art is any suggestion of how to use this concept for the development of affinity phases for the separation of biological macromolecules, e.g. peptides, proteins, oligo- or polynucleotides or oligo- or polysaccharides (see for instance Hart et al., J. Am. Chem. Soc. 123 (2001) 2072-2073). In this regard, new formats for a more efficient exploitation of the epitope approach are needed (Rachkov, et al., Biochim. Biophys. Acta 1544 (2001) 255-266).

In the epitope approach, a smaller peptide corresponding to a unique amino acid sequence of a target protein is used as a template to generate a site that can subsequently selectively bind the larger target molecule. One of the main hurdles with this approach is that it requires that the site is associated with the accessible surface of pores capable of accommodating the larger protein.

### SUMMARY OF THE INVENTION

It is therefore an object of the present invention to disclose a method using dendrimers or other hyperbranched polymers (HBPs) to create affinity phases for the separation of biological macromolecules.

According to a first embodiment of the invention, a dendrimer or another hyperbranched polymer of a size corresponding to the size of a target protein to be recognized by the receptor is used as a template in the imprinting of a polymer. The size of the dendrimer can be precisely controlled through the number of repetitive coupling steps (generations) used in its synthesis

According to further embodiment of the invention, a molecularly imprinted polymer is provided which comprises an imprint of a hyperbranched polymer or a dendrimer.

According to further embodiment of the invention, a method of preparing a molecularly imprinted polymer is provided which comprises mixing a dendrimer or hyperbranched polymer template and at least one functional monomer, polymerizing the mixture, and removing the dendrimer template to provide a molecularly imprinted polymer. The monomer is optionally one of styrenes/divinyl benzenes, methacrylates, acrylates, or acrylamides. The dendrimer or hyperbranched polymer template may be configured to physically resemble a target molecule. The dendrimer or hyperbranched polymer template may comprise at least one ligand such as peptides, saccharides, nucleic acids, amino groups, carboxylic acid groups, phosphates, sulfates, and diols. The target molecule may be a biological macromolecule. The dendrimer or hyperbranched polymer may be removed by extraction. The dendrimer or hyperbranched polymer may be synthesized using reversible linkages and may be removed by degradation and/or dissolution. The mixture may further comprise at least one pore-forming species such as silane-modified silica, controlled pore glass (CPG), porous silica, or porous inorganic oxides.

According to further embodiment of the invention, a molecularly imprinted polymer is provided which is prepared according to the above-stated method.

According to further embodiment of the invention, a chromatographic stationary phase is provided which comprises molecularly imprinted polymers as described above.

According to further embodiment of the invention, a method of recognizing or separating macromolecules from a mixture is provided which comprises providing a molecularly imprinted polymer according to the above, contacting the mixture with the molecularly imprinted polymer under conditions which permit binding of macromolecules to the molecularly imprinted polymer, and separating the mixture from the molecularly imprinted polymer and any macromolecules bound thereto.

The invention contemplates MIPs comprising receptor sites for biological macromolecules obtainable by one of the above methods.

### BRIEF DESCRIPTION OF THE DRAWING FIGURES

FIG. 1 shows reversible linkages that can be used to attach ligands to the surface of dendrimers or other hyperbranched polymers or to synthesize decomposable dendrimers;

FIG. 2 illustrates how the shell of a dendrimer or another hyperbranched polymer can be decorated with ligands to create additional imprinted sites at the surface of the voids created by the dendrimer or HBP. The ligands can be one or more peptides, saccharides, nucleic acids or simple functional groups such as amino groups, carboxylic acid groups, phosphates, sulfates, diols, etc.

FIG. 3 illustrates how the concept shown in FIG. 2 can be used to create binding sites complementary to proteins. FIG. 3A shows a dendrimer or HBP (e.g. polyglycerol) with a shell containing diol, glucose or other saccharide ligands which can be esterified with vinylphenylboronic acid and used as template for placing boronic acid groups at complementary positions in the binding sites of an imprinted polymer. The binding sites are complementary to a proteinacous target, e.g. glycosylated hemoglobin. FIG. 3B shows a dendrimer or HBP (e.g. polyglycerol) with a shell containing phosphate or phenylphosphate groups which can be used as template in molecular imprinting. Using phosphate binding functional monomers, imprinted sites complementary to phosphorylated proteins may be created. The size of the dendrimer and the shell density of phosphate groups can be tuned to complement a given phosphorylated protein target.

FIG. 4 illustrates how dendrimer- or HBP-decorated linear polymers can be used to create pores with dendrimer-imprinted walls in porous network polymers.

FIG. 5 illustrates how dendrimer- or HBP-modified silica can subsequently be used as a template by performing imprinting polymerization inside its pores.

### DETAILED DESCRIPTION OF THE INVENTION

Dendrimers are monodisperse, hyperbranched polymers possessing a very high concentration of surface functional groups. Their unique topology is achieved by the ordered assembly of organic repeating units in concentric, dendritic tiers around an initiator core; this is accomplished by introducing multiplicity and self-replication (within each tier) in a geometrically progressive fashion through a number of molecular generations. The resulting highly functionalized molecules are dendrimers, so named due to their branched (tree-like) structure as well as their oligomeric nature.

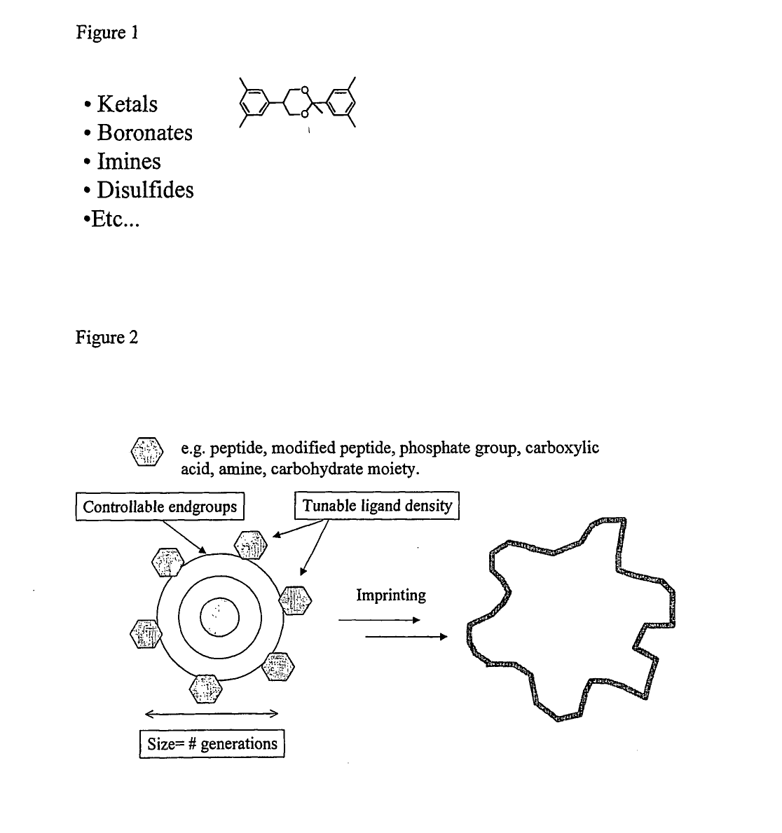

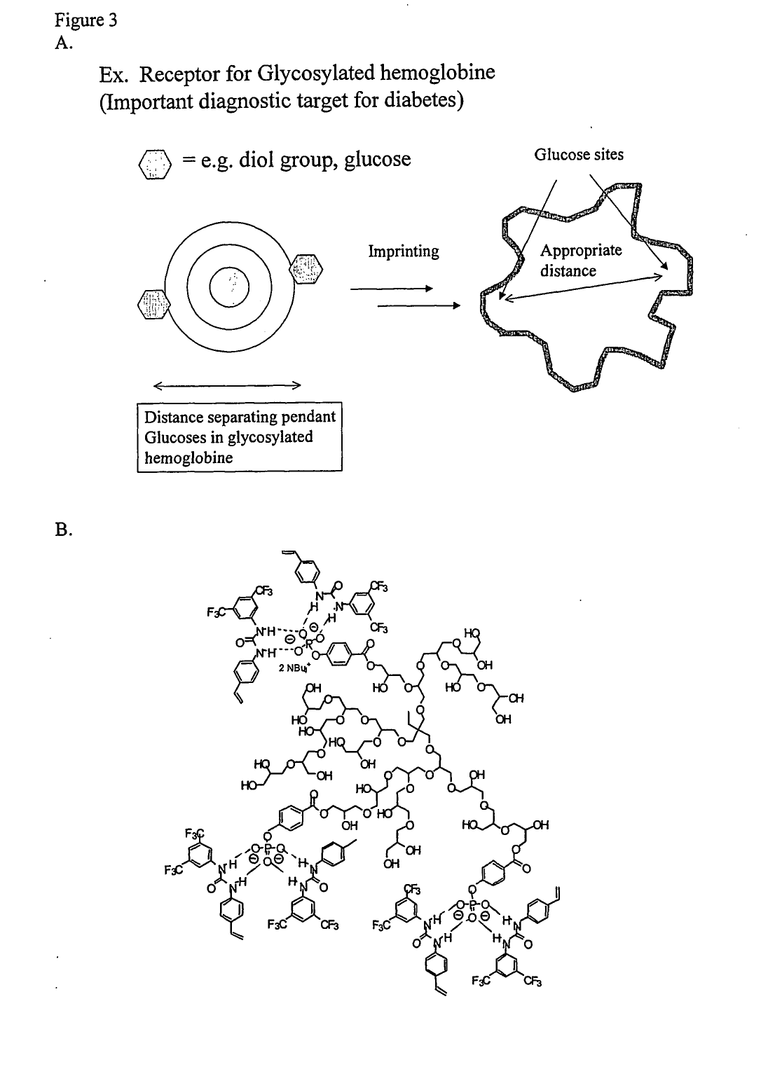

Dendrimers possess three distinguishing architectural features, namely, an initiator core, interior layers or generations composed of repeating units, radially attached to the initiator core, and an exterior surface of terminal functionality attached to the outermost generation. The size and shape of the dendrimer and the functional groups present thereon can be controlled by the choice of the initiator core (e.g., spheroid, cylindrical, rod-shaped, ellipsoid-shaped, or mushroom-shaped), the number of generations employed in creating the dendrimer, and the choice of the repeating units employed at each generation (see FIG. 2). Thus, forming a dendrimer that mimics the size and shape of a biological macromolecule such as a protein is possible. The shells of several dendrimers can also be decorated with ligands (see FIGS. 2 and 3), optionally through reversible linkages, see FIG. 1. The core moiety can be surrounded by three or more dendritic substituents extending therefrom. Examples of core moieties include diols or triols, diamines or triamines, triphenylamine, benzene, pyridine, and pyrimidine. The dendritic substituents typically contain two or more aryl, arylene (e.g., phenylene), heteroaryl, heteroarylene, alkenyl, or alkenylene substituents. In some embodiments, the substituents can be conjugated structures having one or more alkenyl, alkenylene, aryl, arylene (e.g., phenylene, naphthylene, or anthrylene), heteroaryl, or heteroarylene moieties. The dendritic substituents can be the same or different. Examples of dendritic compounds include starburst compounds based on triphenylamines and dendrimers or hyperbranched polymers such as polyamidoamine (PAMAM), polyethyleneimine (PEI), polypropyleneamine (POPAM) and polyglycerol (PG).

Dendrimers can optionally be synthesized entirely with reversible linkages to build up each new generation. This allows degradation and/or dissolution of the dendrimer after it is formed. For instance, using a dendritic substituent consisting of 2-(3,5-diacetophenyl)-1,3-propanediol would allow a dendritic structure held together by ketal linkages to be synthesized. Such a dendritic structure could be decomposed using an acid wash.

As an alternative to perfect dendrimers, where each shell is generated in a stepwise fashion, less defined hyperbranched polymers formed from one-pot reactions can alternatively be used. Polyethyleneimine and polyglycerol can be produced in this way. Polyglycerol, for instance, can be produced through controlled ring opening polymerization of glycidol using alkoxide initiators (Sunder et al., Macromolecules 32, (1999), 240).

Using the unique features of dendrimers or HBPs, the present invention provides a new method using dendrimers or HBPs as templates to create voids in polymeric materials. After polymerization, the dendrimer or HBP is removed. This can be done, for example, by extraction or by decomposing the complete dendrimer as described above. This leaves voids in the polymeric material controlled by the size of the dendritic template. The surface configuration of such voids can also be manipulated by controlling the shell structure of the dendrimer.

For example, using a dendrimer or HBP containing a shell with basic functional groups (e.g. amines) and an acidic monomer in the imprinting step (e.g. methacrylic acid) creates voids complementary to target molecules with the size and density of amine or other acid-interacting groups corresponding to that of the dendrimer or HBP used as template. By controlling the shell ligand density (the number of amino groups) of the dendrimer, the density of acid groups can be adjusted in the voids to complement a given target molecule. The reverse is also possible. That is, it is possible to use an acid functionalized dendrimer or HBP to create a basic functionalized imprinted site. Monomers which may be used with the present invention include styrenes/divinyl benzenes, methacrylates, acrylates, and acrylamides. In particular hydrophilic monomers may be used to create a hydrophilic polymer matrix. Examples of such crosslinking monomers are pentaerythritol triacrylate and methylenbisacrylamide. Examples of hydrophilic comonomers are 2-hydroxyethylmethacrylate, oligoethylenglycol-containing monomers, acrylamide, methacrylamide, N-vinylpyrrolidone.

As depicted in FIG. 2, in addition to simple functional group motives (e.g. carboxylic acid or amine groups, phosphate, diols, sulphonate, etc.) the shell of the dendrimer or HBP can alternatively be decorated with ligands such as peptides or sugars to create additional imprinted sites at the surface of the voids created by the dendrimer. These sites are complementary to substructures of a larger target molecule, e.g. sugars of a glycosylated peptide or protein (FIG. 3), phosphate groups of phosphorylated proteins or peptides, or surface-exposed peptide epitopes. One example of a target that could benefit from such an approach is glycosylated hemoglobin (FIG. 3A), an important target in the search for diagnostic tools for diabetes. Other suitable targets are phosphorylated peptides or proteins or classes of such targets (FIG. 3B).

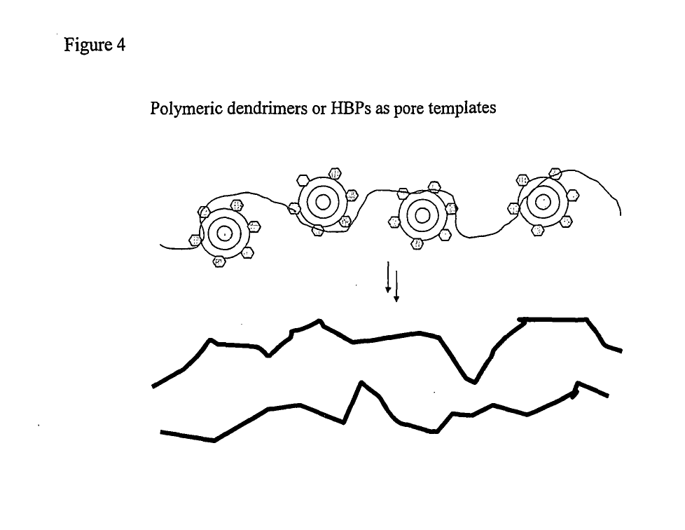

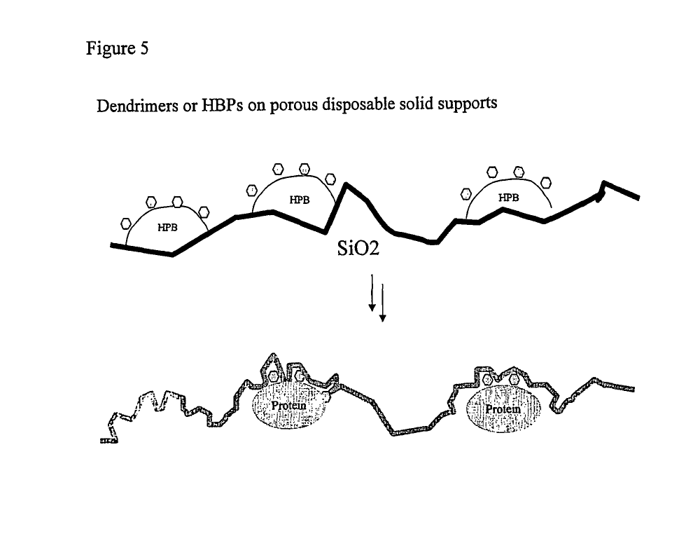

Dendrimers may also be combined with other pore-forming species in order to increase the accessibility to the voids. Examples of pore-forming species include silane-modified silica, controlled pore glass (CPG), porous silica, and porous inorganic oxides. Increasing accessibility to the voids can also be done by coupling the dendrimers to linear polymers or by synthesizing linear polymers using the dendrimer as monomer (FIG. 4). Alternatively, the dendrimer or a corresponding hyperbranched polymer can be attached to silica (FIG. 5). The dendrimer-modified silica can subsequently be used as a template by performing imprinting polymerization inside its pores. After fluoride-catalyzed dissolution of the silica, doubly hierarchically imprinted materials remain containing an accessible pore structure in combination with voids complementary to biological macromolecules.

Forming MIPs with dendrimers can be done according to known techniques for MIP formation. MIPs are commonly produced in the presence of a template through free radical polymerization of functional, unsaturated monomers (vinyl-, acryl-, methacryl-) and an excess of di- or tri-unsaturated monomers (vinyl-, acryl-, methacryl-) as cross-linkers whereby porous organic networks are produced. Most of the non covalent molecular imprinting systems are based on acryl- or methacryl monomers, such as for instance methacrylic acid (MAA), which is cross-linked with ethyleneglycol dimethacrylate (EDMA). Alternatively, hydrophilic monomers may be used to create a hydrophilic polymer matrix compatible with protein recognition. Examples of such crosslinking monomers are pentaerythritol triacrylate and methylenbisacrylamide. Examples of hydrophilic comonomers are 2-hydroxyethylmethacrylate, oligoethylenglycol-containing monomers, acrylamide, methacrylamide, and N-vinylpyrrolidone.

While the present invention has been described with specificity in accordance with certain of its preferred embodiments, the following examples serve only to illustrate the invention and are not intended to limit the same. If sources are not specifically described materials are known and commercially available. The practice of the present invention employs, unless otherwise indicated, conventional techniques which are within the skill of the art and which are explained fully in the literature.

### EXAMPLE 1

### Amino- or Carboxylic Acid-Functionalized MIP Material

The following can be used to produce a MIP using an amino-functionalized dendrimer or hyperbranched polymer (HBP) (e.g. PAMAM, polyethyleneimine, POPAM) as the template:
80 mg Azo initiator (i.e. AIBN).
0.1 g HBP
0.7 ml MAA: methacrylic acid (functional monomer)
7.6 ml EDMA: ethyleneglycol dimethacrylate (crosslink monomer)
11.2 ml Toluene

A pre-polymerization mixture is prepared consisting of the template, MAA and EDMA, dissolved in toluene. The amount of MAA may be adjusted to reach 1:1 stoichiometry vis á vis the number of peripheral amino groups on the template. The polymerization is then initiated by means of UV light, or thermally at elevated temperatures.

During this period the mixture is purged with nitrogen. After polymerization the MIP material is crushed and the particles washed with methanol by means of Soxhlet extraction and then dried.

Instead of using an amino-functionalized HBP, an acid-functionalized HBP can be used and an amino-functional monomer (e.g. diethylaminoethylmethacrylate) as functional monomer to prepare an amino-functionalized MIP. The number of generations and the density of peripheral functional groups on the dendrimer can be adjusted as desired.

### EXAMPLE 2

### Boronate-Functionalized MIP Material

The following can be used to produce a MIP using a diol-functionalized dendrimer or hyperbranched polymer (HBP, e.g. hyperbranched polyglycerol) as template:
80 mg Azo initiator (i.e. AIBN).
0.1 g HBP
0.7 ml 4-Vinylphenylboronic acid (VPB, functional monomer)
7.6 ml EDMA: ethyleneglycol dimethacrylate (crosslink monomer)
11.2 ml Toluene

Prior to polymerization the template and VBP are reacted to reach the desired stoichiometry between polymerizable groups and the HBP. The amount of VPB may be adjusted to reach 1:1 stoichiometry vis a vis the number of peripheral diol groups on the template. A pre-polymerization mixture is prepared consisting of the VBP modified template and EDMA, dissolved in toluene. The polymerization is then initiated by means of UV light, or thermally at elevated temperatures.

During this period the mixture is purged with nitrogen. After the polymerization the MIP material is crushed and the particles washed with 0.1M HCl in methanol and by means of Soxhlet extraction and then dried. The number of generations and the density of peripheral functional groups on the dendrimer can be adjusted as described above.

### EXAMPLE 3

### Urea-Functionalized MIP Material

The following can be used to produce a MIP using a phosphorylated hyperbranched polymer (HBP, e.g. hyperbranched polyglycerol) as template:

Hyperbranched polymers (HBPs), e.g. poly(glycerols) can be prepared in a controlled manner to obtain protein-sized structures. For example, a poly(glycerol) HBP of molecular weight=8,000 D exhibits a hydrodynamic diameter of ca. 8 nm. After synthesis, a portion of the hydroxyl groups at the periphery of the HBP is functionalized with —P(O)(OH)₂ groups, thus creating a generic template to create MIPs capable of the recognition of phosphorylated peptides and proteins (including those containing phosphorylated serine and threonine residues). Such templates are created by the reaction of the HBPs with suitable phosphoramidite reagents. Oxidation of the product, followed by cleavage of the phosphate esters leads to the template molecules. HBPs “decorated” with -PhOP(O)(OH)₂ groups can be prepared according to this example with the aim of creating MIPs with selectivity for only phosphotyrosine-modified peptides and proteins.

The procedure for preparation of a phosphoprotein complementary polymer involves:

80 mg Azo initiator (i.e. AIBN).
0.1 g HBP
0.7 g 1-styryl-3-bis(trifluoromethyl)phenyl-urea (TFU)+Triethylamine (1 eq. Vis á vis number of phosphate groups)
7.6 ml EDMA: ethylene glycol bismethacrylate (crosslink monomer)
11.2 ml THF

A pre-polymerization mixture is prepared consisting of the template, TFU, triethylamine, and EDMA, dissolved in THF. The amount of TFU may be adjusted to reach 1:1 stoichiometry vis á vis the number of peripheral diol groups on the template. The polymerization is then initiated by means of UV light, or thermally at elevated temperatures.

During this period the mixture is purged with nitrogen. After the polymerization the MIP material is crushed and the particles washed with 0.1M HCl in methanol and by means of Soxhlet extraction and then dried. The number of generations and the density of peripheral functional groups on the dendrimer can be adjusted as described above.

### EXAMPLE 4

### Use of the MIPs According to Examples 1-3 for Binding Macromolecules

The MIPs according to any of the above examples can be used for the selective binding of peptide or protein targets containing surface functional groups complementary to the HBP imprinted polymer. This process can be achieved under static conditions in a batch wise process or as recognition elements in chemical sensors. It can also be achieved under dynamic conditions using the MIP as a stationary phase in chromatography in any form or in continuous separation formats such as membrane-based separations.

As noted above, the following examples serve only to illustrate specific embodiments of the invention. Other methods and materials would be compatible with the practice of the present invention. These include alternate prepolymerization mixtures incorporating the template, alternate methods for polymerization, alternate methods of releasing MIPs and alternate washing methods and materials for the MIPs.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A molecularly imprinted polymer comprising an imprint of a hyperbranched polymer or a dendrimer.

2. A method of preparing a molecularly imprinted polymer, comprising: mixing a dendrimer or hyperbranched polymer template and at least one functional monomer; polymerizing the mixture; and removing the dendrimer template to provide a molecularly imprinted polymer.

3. A method according to claim 2, wherein the monomer is selected from the group consisting of: styrenes/divinyl benzenes, methacrylates, acrylates, and acryla-mides.

4. A method according to claim 2, wherein the dendrimer or hyperbranched polymer template is configured to physically resemble a target molecule.

5. A method according to claim 4, wherein the dendrimer or hyperbranched polymer template comprises at least one ligand selected from the group consisting of: peptides, saccharides, nucleic acids, amino groups, carboxylic acid groups, phosphates, sulfates, and diols.

6. A method according to claim 2, wherein the target molecule is a biological macromolecule.

7. A method according to claim 2, wherein the dendrimer or hyper-branched polymer is removed by extraction.

8. A method according to claim 2, wherein the dendrimer or hyper-branched polymer is synthesized using reversible linkages.

9. A method according to claim 8, wherein the dendrimer or hyperbranched polymer is removed by degradation and/or dissolution.

10. A method according to claim 2, wherein the mixture further comprises at least one pore-forming species.

11. A method according to claim 10, wherein the pore-forming species is selected from the group consisting of: silane-modified silica, controlled pore glass (CPG), porous silica, and porous inorganic oxides.

12. A molecularly imprinted polymer prepared according to the method of any one of claims 2-11.

13. A chromatographic stationary phase, comprising molecularly imprinted polymers according to any one of claims 1-12.

14. A method of recognizing or separating macromolecules from a mixture, comprising: providing a molecularly imprinted polymer according to any one of claims 1-12; contacting the mixture with the molecularly imprinted polymer under conditions which permit binding of macromolecules to the molecularly imprinted polymer; and separating the mixture from the molecularly imprinted polymer and any macromolecules bound thereto.

15. A method according to claim 4, wherein the dendrimer or hyperbranched polymer template is configured to physically resemble a target molecule.

16. A method according to claim 15, wherein the dendrimer or hyperbranched polymer template comprises at least one ligand selected from the group consisting of: peptides, saccharides, nucleic acids, amino groups, carboxylic acid groups, phosphates, sulfates, and diols.

17. A method according to claim 16, wherein the target molecule is a biological macromolecule.

18. A method according to claim 17, wherein the dendrimer or hyperbranched polymer is removed by extraction.

19. A method according to claim 18, wherein the dendrimer or hyperbranched polymer is synthesized using reversible linkages.

20. A method according to claim 19, wherein the dendrimer or hyperbranched polymer is removed by at least one of degradation and dissolution.

21. A method according to claim 20, wherein the mixture further comprises at least one pore-forming species.
